(19) United States
(12) Patent Application Publication
(10) Pub. No.: US 2008/0110155 A1
(43) Pub. Date: May 15, 2008

(54) Exhauster for Motorcycle and Motorcycle Including Exhauster

(75) Inventor: Keiichi HARADA, Shizuoka (JP)

Correspondence Address: HOGAN & HARTSON L.L.P., 1999 AVENUE OF THE STARS, SUITE 1400, LOS ANGELES, CA, 90067, US

(73) Assignee: YAMAHA HATSUDOKI KABUSHIKI KAISHA, Iwata-shi (JP)

(21) Appl. No.: 11/877,528

(22) Filed: Oct. 23, 2007

(30) Foreign Application Priority Data
Oct. 24, 2006 (JP) 2006-288460

(51) Int. Cl. F01N 3/035; F01N 7/00; B62K 11/00

(52) U.S. Cl. 60/276; 60/299; 60/324; 180/219; 181/227

(57) ABSTRACT

An exhauster for a motorcycle with a reduced number of components and reduced cost in a structure containing a variable passage area valve. An exhaust chamber has a box-shaped chamber main body, a plurality of expansion chambers a through c formed by sectioning the interior of the chamber main body with partitioning walls, and communication passages for connecting the expansion chambers a through c with one another. A variable passage area valve that controls passage area is contained in the communication passage.

### RELATED APPLICATIONS

This application claims the benefit of priority under 35 USC 119 of Japanese patent application nos. 2006-288460, filed on Oct. 24, 2006, which application is hereby incorporated by reference in its entirety.

### BACKGROUND OF THE INVENTION

1. Field of the Invention

The present invention relates to an exhauster for a motorcycle that has a first exhaust pipe connected with an engine, an exhaust chamber connected with the first exhaust pipe, and a second exhaust pipe connected with the exhaust chamber.

2. Description of Related Art

An exhauster for a motorcycle having a V-type four-cylinder engine in related art includes left and right front exhaust pipes connected with left and right front cylinders, left and right rear exhaust pipes connected with left and right rear cylinders, an expansion chamber connected with these four exhaust pipes, and a pair of left and right mufflers connected with the expansion chamber (for example, see JP-B-7-111139).

According to JP-B-7-111139, a pair of left and right exhaust control valves (passage area control mechanism) for varying passage area is provided at downstream end openings of the left front and rear exhaust pipes and at downstream end openings of the right front and rear exhaust pipes inside the expansion chamber so as to improve engine output.

An exhauster structure in the related art containing a pair of passage area control mechanisms on both the left and right sides within the expansion chamber has disadvantages in an increased number of components and increased costs.

### SUMMARY OF THE INVENTION

The invention has been developed to solve the problems in the related art, and provides an exhauster for a motorcycle with a reduced number of components and reduced cost in a structure containing a passage area control mechanism.

An exhauster for a motorcycle according to the invention includes a first exhaust pipe connected with an engine, an exhaust chamber connected with the first exhaust pipe, and a second exhaust pipe connected with the exhaust chamber. The exhaust chamber has a box-shaped chamber main body, a plurality of expansion chambers formed by sectioning the interior of the chamber main body with partitioning walls, and communication passages connecting the respective expansion chambers with one another. A passage area control mechanism capable of controlling passage area is contained in at least in one of the communication passages.

According to the invention, the interior of the exhaust chamber is sectioned into plural expansion chambers, and the passage area control mechanism is contained in at least in one of the communication passages for connecting the respective expansion chambers with one another. Thus, only one passage area control mechanism is required even for a plural-cylinder engine having plural exhaust pipes, which reduces the number of components and reduces costs.

Moreover, since the passage area control mechanism is contained in any of the communication passages for Connecting the respective expansion chambers with one another, the communication passage can be used as a component constituting a part of the passage area control mechanism, thereby simplifying the valve structure.

Other features and advantages of the invention will be apparent from the following detailed description, taken in conjunction with the accompanying drawings which illustrate, by way of example, various features of embodiments of the invention.

### BRIEF DESCRIPTION OF THE DRAWINGS

FIG. 1 is a side view of a motorcycle including an exhauster according to an embodiment of the invention.

FIG. 2 is a side view of an engine connected with the exhauster and mounted on a body frame.

FIG. 3 is a side view of the exhauster.

FIG. 4 is a plan view of the exhauster.

FIG. 5 is a plan view illustrating an exhaust chamber of the exhauster.

FIG. 6 is a side view of the exhaust chamber.

FIG. 7 is a rear cross-sectional view of the exhaust chamber.

### DETAILED DESCRIPTION OF THE INVENTION

An embodiment of the invention is now described with reference to the appended drawings.

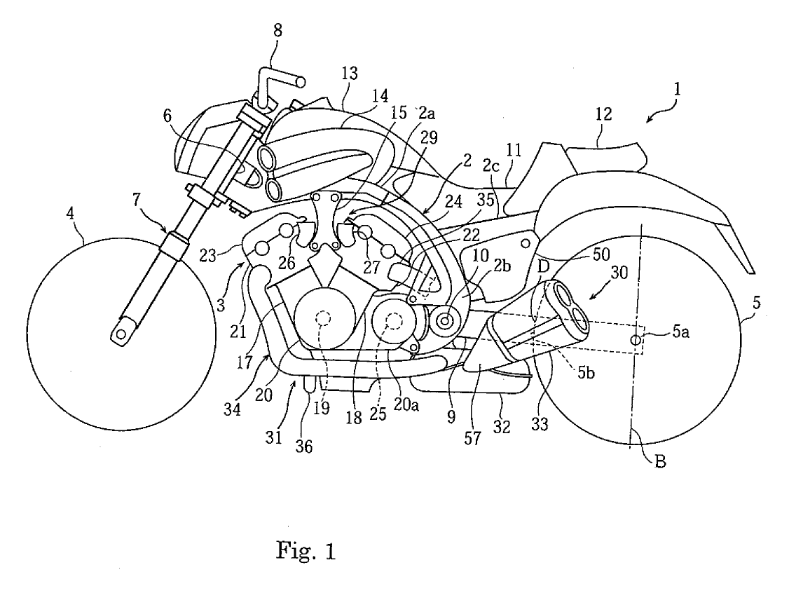

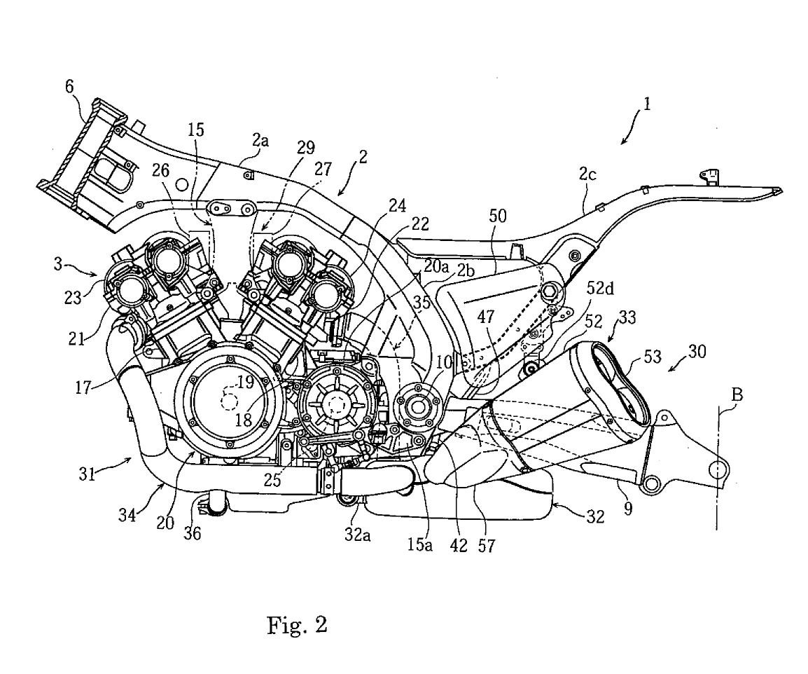

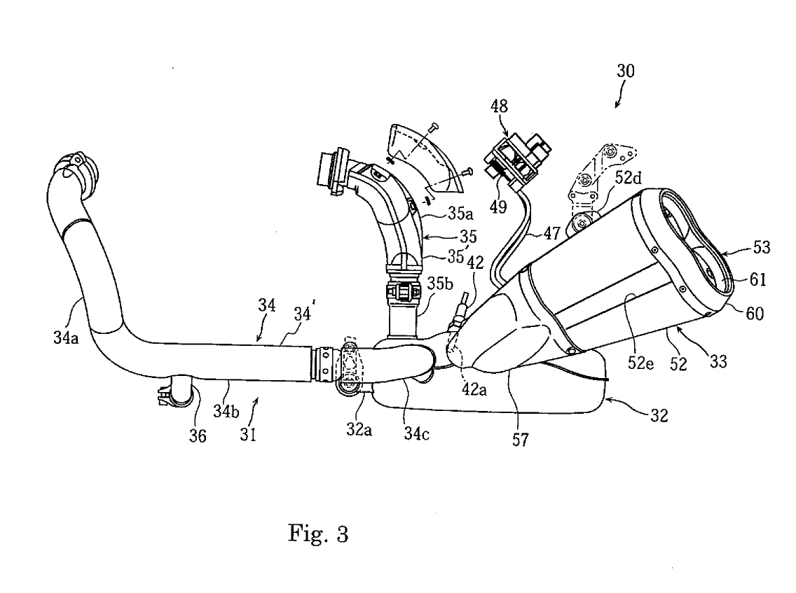

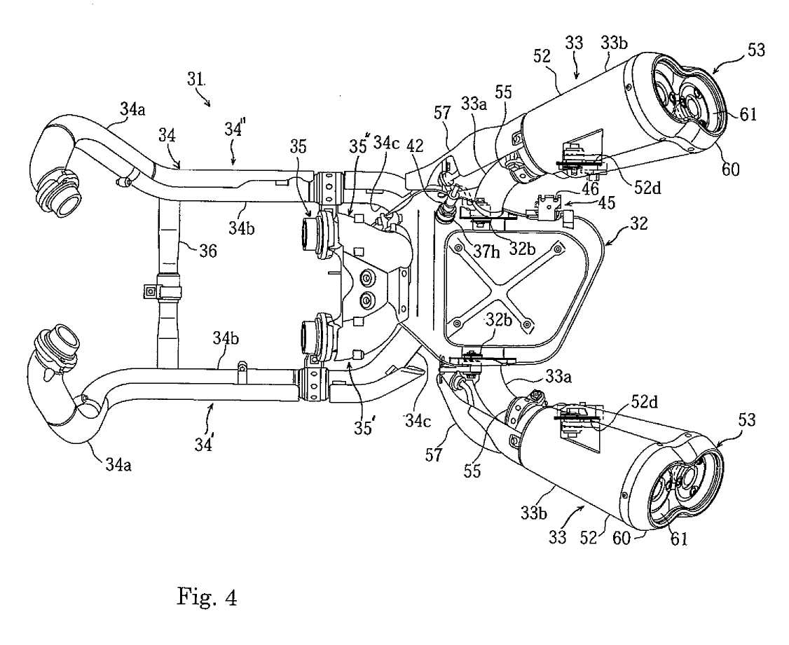

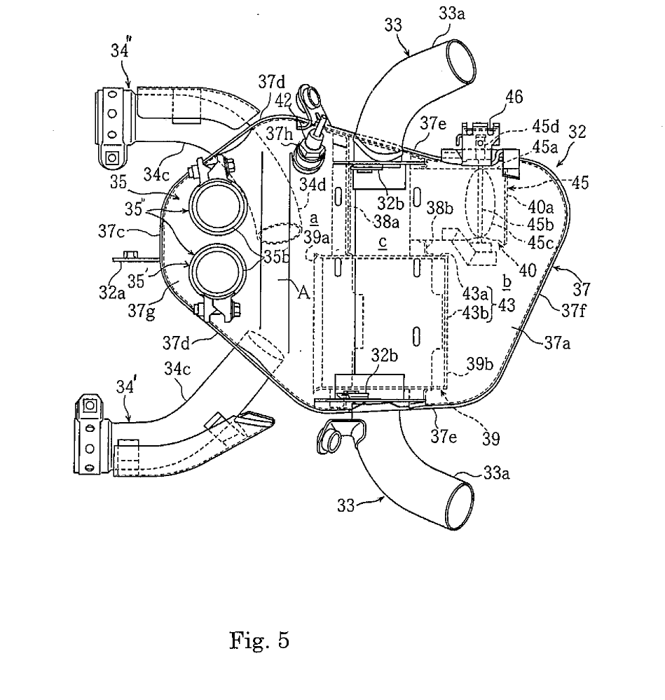

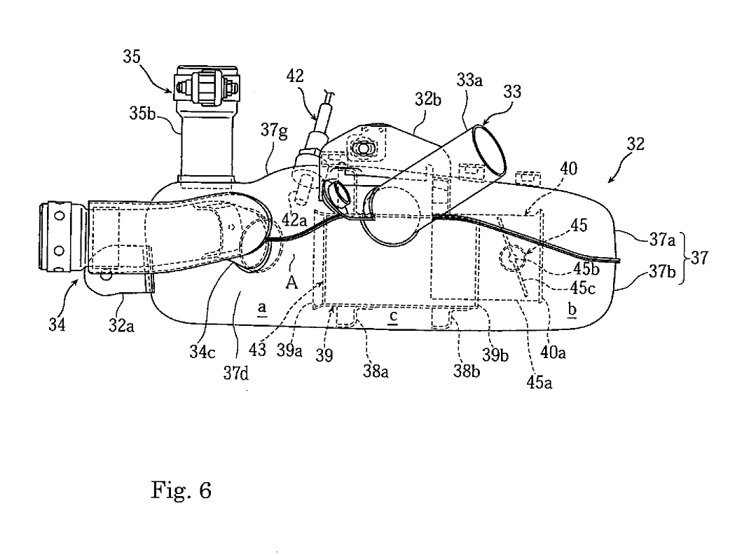

FIGS. 1-7 illustrate an exhauster for a motorcycle according to an embodiment of the invention. The front-rear and left-right directions in this embodiment refer to front-rear and left-right directions from the perspective of a person sitting on a seat.

In the figures, a motorcycle 1 includes a twin-spar-type body frame 2, an engine 3 mounted on body frame 2, and a front wheel 4 and a rear wheel 5 provided at the front and rear of body frame 2, respectively.

A head pipe 6 is provided at the front end of body frame 2. Left and right main frames 2a extend diagonally downward to the rear from head pipe 6 while expanding to the left and right, and left and right seat rails 2c extend diagonally upward to the rear from main frames 2a. A rear arm bracket unit 2b is disposed behind main frames 2a.

A front fork 7 is supported by head pipe 6 so as to be steered to the left and right. Front wheel 4 is supported at the lower end of front fork 7, and a steering handle 8 is fixed to the upper end of front fork 7.

The front end of a rear arm 9 is supported by rear arm bracket unit 2b via a pivot shaft 10 such that rear arm 9 can swing upward and downward. Rear wheel 5 is supported by the rear end of rear arm 9.

A straddle-type main seat 11 and a tandem seat 12 positioned behind main seat 11 are mounted on left and right seat rails 2c. A tank cover 13 is provided before main seat 11 as an external component.

Engine 3 is a four-stroke V-type four-cylinder engine having left and right front cylinders and left and right rear cylinders so disposed as to form a V-bank. The upper area of engine 3 is suspended by left and right suspension brackets 15, 15 fixed to left and right main frames 2a. The rear wall of engine 3 is suspended by a suspension bracket 15a fixed to rear arm bracket unit 2b, or by other components.

Engine 3 has a structure formed by connecting a crank case 20 containing a crank shaft 19 with lower engaging surfaces of front and rear cylinder blocks 17 and 18 forming a V-bank, connecting front and rear cylinder heads 21 and 22 with upper engaging surfaces of front and rear cylinder blocks 17 and 18, and attaching front and rear head covers 23 and 24 to front and rear cylinder heads 21 and 22.

A transmission case 20a containing a transmission mechanism is connected with the rear of crank case 20 as one body. The upper and bottom walls of transmission case 20a are fastened to rear frame 2b by bolts. Engine 3 has an output shaft 25 for outputting the driving force of engine 3.

An intake unit 29 of engine 3 has left front and right front intake pipes 26 and left rear and right rear intake pipes 27 provided on the V bank inside walls of front and rear cylinder heads 21 and 22 and communicating with left front and right front intake ports and left rear and right rear intake ports, respectively, and a throttle body connected with left and right front and rear intake pipes 26 and 27, and a common air cleaner connected with the throttle body.

The air cleaner is disposed below tank cover 13 between left and right main frames 2a, and left and right front and rear intake pipes 26 and 27 extend upward substantially in the vertical direction from the V-bank inside walls. Left and right intake ducts 14 and 14 for supplying air to engine 3 are disposed on the left and right sides of tank cover 13. Left and right air intake ducts 14 are connected with the air cleaner.

An exhauster 30 of engine 3 has an upstream (first) exhaust pipe 31 connected with engine 3, an exhaust chamber 32 connected with upstream exhaust pipe 31, and left and right mufflers (second exhaust pipes) 33, 33 connected with exhaust chamber 32. First exhaust pipe 31 has a third exhaust pipe 34 through which exhaust gas flows into a first expansion chamber a of exhaust chamber 32 from the outside to the inside substantially in the vehicle width direction, and a fourth exhaust pipe 35 through which exhaust gas flows into first expansion chamber a of exhaust chamber 32 from the upper side to the lower side substantially in the up-down direction. Third exhaust pipe 34 has a fifth exhaust pipe 34′ connected with left front cylinder 17, and a sixth exhaust pipe 34″ connected with right front cylinder 17. Fourth exhaust pipe 35 has a seventh exhaust pipe 35′ connected with left rear cylinder 18, and an eighth exhaust pipe 35″ connected with right rear cylinder 18. The details of this structure are as follows.

Upstream exhaust pipe 31 has left and right transverse exhaust pipes (fifth and sixth exhaust pipes) 34′ and 34′ connected with the V bank outside wall (front wall) of front cylinder head 21 and communicating with left and right front exhaust ports open to this outside wall, and left and right longitudinal exhaust pipes (seventh and eighth exhaust pipes) 35′ and 35″ connected with the V bank outside wall (rear wall) of rear cylinder head 22 and communicating with left and right rear exhaust ports open to this outside wall.

Each of left and right transverse exhaust pipes 34′ and 34″ has a downward inclined portion 34a extending downward from front cylinder head 21 while expanding to the outside in the vehicle width direction, a horizontal portion 34b extending from the lower end of inclined portion 34a through the lower side of crank case 20 to the rear substantially in a linear direction, and a transverse curved portion 34c extending from the rear end of horizontal portion 34b while curving toward the inside in the vehicle width direction. Left and right horizontal portions 34b are connected with each other via a communication pipe 36 extending in the vehicle width direction such that left and right horizontal portions 34b can communicate with each other.

Each of left and right longitudinal exhaust pipes 35′ and 35″ has a longitudinal curved portion 35a extending from rear cylinder head 22 through the rear side of transmission case 20a while curving downward, and a vertical portion 35b extending downward from longitudinal curved portion 35a substantially in a linear direction.

Exhaust chamber 32 is disposed between transmission case 20a of engine 3 and rear wheel 5 below rear arm 9 containing pivot shaft 10. A front flange 32a projecting from the front end of exhaust chamber 32 is attached to crank case 20. Left and right flanges 32b and 32b rising from the left and right edges of the upper wall of exhaust chamber 32 are attached to rear frame 2b via a bracket.

Exhaust chamber 32 has a closed-box-shaped chamber main body 37 formed by combining the outer edges of an upper member 37a and a lower member 37b, first, second and third expansion chambers a through c formed by sectioning the interior of chamber main body 37 in the front rear direction by first and second partitioning walls 38a and 38b, a first communication passage 39 through which first expansion chamber a communicates with second expansion chamber b, and a second communication passage 40 through which second expansion chamber b communicates with third expansion chamber c.

First through third expansion chambers a through c are disposed such that first expansion chamber a, third expansion chamber c, and second expansion chamber b are positioned in this order from the front. Second expansion chamber b is located between first expansion chamber a connected with left and right transverse exhaust pipes 34 and left and right longitudinal exhaust pipes 35, and third expansion chamber c connected with left and right mufflers 33 as viewed in the exhaust gas flowing direction.

The volume of first expansion chamber a is larger than each volume of second and third expansion chambers b and c. The volume of second expansion chamber b is larger than the volume of third expansion chamber c.

Chamber main body 37 has a substantially hexagonal shape having a front end wall 37c, left and right front inclined walls 37d, 37d extending from front end wall 37c to the rear while diagonally expanding to the outside, left and right side walls 37e, 37e extending from left and right front inclined walls 37d to the rear, and a rear wall 37f connecting the rear ends of left and right side walls 37e in the vehicle width direction.

Transverse curved portions 34c, 34c of left and right transverse exhaust pipes 34′, 34″ are connected with left and right front inclined walls 37d of chamber main body 37 such that transverse curved portions 34c, 34c can communicate with first expansion chamber a. Thus, exhaust gas flowing within left and right transverse exhaust pipes 34′, 34″ flows into first expansion chamber a from the outside to the inside in the vehicle width direction.

Right transverse exhaust pipe 34″ has an extension 34d extending from transverse curved portion 34c toward the center of first expansion chamber a. Extension 34d is disposed behind left and right longitudinal exhaust pipes 35′, 35″ in first expansion chamber a, and is open to the center of exhaust pipes 35′, 35″ in the vehicle width direction.

Vertical portions 35b, 35b of left and right longitudinal exhaust pipes 35′, 35″ are disposed in parallel in the vicinity of front end wall 37c of chamber main body 37 in the vehicle width direction, and are connected with first expansion chamber a such that vertical portions 35b, 35b can communicate with first expansion chamber a. Thus, exhaust gas flowing within left and right longitudinal exhaust pipes 35, 35″ flows into first expansion chamber a from the upper side to the lower side in the up-down direction.

A boss 37h is provided at an end of a top wall 37g of chamber main body 37 at an inner position in the vehicle width direction such that boss 37h can communicate with first expansion chamber a. A detection unit 42a of an oxygen concentration detection sensor 42 is inserted through boss 37h such that detection unit 42a can reach the interior of first expansion chamber a. Oxygen concentration detection sensor 42 is surrounded by chamber main body 37, left and right rear frames 2b, pivot shaft 10, and rear arm 9 such that oxygen concentration detection sensor 42 is protected from damage caused by external force.

Oxygen concentration detection sensor 42 is disposed at a position away from a junction portion A of left and right transverse exhaust pipes 34′ and 34″ and left and right longitudinal exhaust pipes 35′ and 35″ in first expansion chamber a. Extension 34d is disposed at a position to guide exhaust gas in a direction away from oxygen concentration detection sensor 42. The exhaust gases flowing from the respective exhaust pipes are mixed, and the gas after mixture contacts detection unit 42a of oxygen concentration detection sensor 42.

First communication passage 39 penetrates through first and second partition walls 38a and 38b for defining third expansion chamber c such that first expansion chamber a can communicate with second expansion chamber b. First communication passage 39 is disposed on the side opposite to oxygen concentration sensor 42 of chamber main body 37 as viewed from above, and an exhaust gas inlet 39a of first communication passage 39 is positioned in the vicinity of exhaust gas junction portion A of first expansion chamber a.

A catalyst 43 is contained in first communication passage 39. Catalyst 43 has a honeycomb-shaped catalyst main body 43b inside a metal cylindrical body 43a constituting communication passage 39. Catalyst main body 43b has a function for purifying exhaust gas.

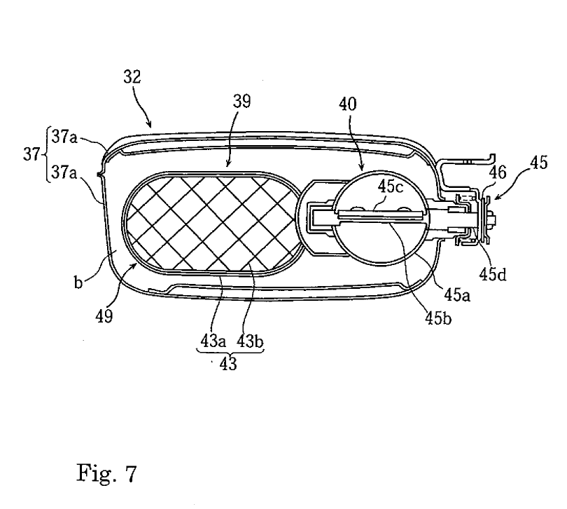

Catalyst 43 is elliptical in the lateral cross-sectional view, and is disposed such that the major axis of the ellipse extends in the vehicle width direction (see FIG. 7).

Second communication passage 40 disposed in the vicinity of right wall 37e of chamber main body 37 penetrates through second partition wall 38b in such a condition that second expansion chamber b communicates with third expansion chamber c. Second communication passage 40 is positioned on the right side of first communication passage 39 in parallel, and an exhaust gas inlet 40a of second communication passage 40 is offset from an exhaust gas output 39b of first communication passage 30 toward the rear of the vehicle.

Exhaust gases from the respective cylinders flow through left and right transverse exhaust pipes 34′ and 34″ and left and right longitudinal exhaust pipes 35′ and 35″ into first expansion chamber a of exhaust chamber 32. Exhaust gas mixed at first expansion chamber a flows through catalyst 43 in first communication passage 39 into second expansion chamber b. Then, the exhaust gas flows from second expansion chamber b through second communication passage 40 into third expansion chamber c, from which the exhaust gas flows through left and right mufflers 33 to be released to the outside.

Second communication passage 40 contains a variable passage area valve passage area control mechanism) 45 that controls the passage area of communication passage 40.

Variable passage area valve 45 has a cylindrical communication pipe 45a constituting second communication passage 40, a valve shaft 45b disposed to penetrate through communication pipe 45a in the vehicle width direction, and a valve plate 45c fixed to valve shaft 45b in such a position as to lie within communication pipe 45a.

Valve shaft 45b is so located as to extend in the vehicle width direction, and the right end of valve shaft 45b penetrates through right wall 37e of chamber main body 37 to project to the outside. A driven pulley 46 attached to a projecting portion 45d of valve shaft 45b is connected with a drive pulley 49 attached to a rotation shaft of a drive motor 48 via a cable 47. Drive motor 48 is contained in a side cover 50 below seat frames 2c.

Variable passage area valve 45 is opened and closed by operation of a controller that detects operation conditions of the engine based on engine revolutions, engine load and other conditions, and controls the opening of variable passage area valve 45 according to the engine operation conditions.

Left and right mufflers 33 have downstream exhaust pipes 33a, 33a connected with left and right side walls 37e, 37e of exhaust chamber 32 in such a condition as to communicate with third expansion chamber c, and muffler main bodies 33b, 33b connected with left and right downstream exhaust pipes 33a in such a condition as to be attachable to and detachable from downstream exhaust pipes 33a.

As illustrated in FIG. 1, left and right mufflers 33 are disposed before a vertical line B passing through the center of a rotation axis 6a of rear wheel 5. A center D of left and right mufflers 33 in the front-rear direction is positioned in the vicinity of a front edge 5b of rear wheel 5.

Left and right mufflers 33 extend diagonally upward to the rear from exhaust chamber 32 while expanding to the outside in the vehicle width direction.

Each of left and right muffler main bodies 33b attached to the vehicle body via an attachment bracket 52d has a casing 52 that surrounds the outer circumference of a tail pipe connected with downstream exhaust pipe 33a via a joint 55, and a tail cap 53 so attached as to cover a rear end wall of casing 52. Tail cap 53 has a ring-shaped outer cap 60 surrounding the rear edge of casing 52, and an inner cap 61 disposed to cover the rear end wall of casing 52.

An outside cover 57 that covers the external side of downstream exhaust pipe 33a is provided between casing 52 and exhaust chamber 32. Outside cover 57 has a tapered shape which narrows from the casing 52 side to the upstream side (lower side), and constitutes a part of casing 52.

According to this embodiment, first expansion chamber a is linked to left and right transverse exhaust pipes 34′ and 34″ connected with left and right front cylinders of V-type four-cylinder engine 3, and is linked to left and right longitudinal exhaust pipes 35′ and 35″ connected with left and right rear cylinders of engine 3. Third expansion chamber c is linked to left and right mufflers 33; and second expansion chamber b is interposed between first and third expansion chambers a and c as viewed in the flowing direction of exhaust gas. This structure securely provides the three expansion chambers while maintaining the compactness of chamber main body 37, resulting in an increase in the substantial exhaust pipe length and an improved muffling effect.

According to the exhauster of this embodiment, left and right transverse exhaust pipes 34, and 34″ and left and right longitudinal exhaust pipes 35′ and 35″ are connected with single exhaust chamber 32, and variable passage area valve 45 is contained in second communication passage 40 through which the respective expansion chambers can communicate with one another. Thus, only the single variable passage area valve 45 is required even in case of a four-cylinder engine having four exhaust pipes 34′, 34′, 35′, and 35″, which reduces the number of components and reduces costs.

Second communication passage 40 through which second expansion chamber b communicates with third expansion chamber c functions as communication pipe 45a of variable passage area valve 45. Thus, the number of components is decreased and the valve structure is simplified. In addition, since second communication passage 40 is disposed in the vicinity of right wall 37e of chamber main body 37, valve shaft 45b can project toward chamber main body 37 without necessity for extension of valve shaft 45b. Accordingly, the structure containing the open/close driving mechanism can be simplified. Furthermore, since valve shaft 45b extends in the vehicle width direction, the size of exhaust chamber 32 in the up-down direction decreases. As a result, the minimum road clearance is widened.

According to this embodiment, left and right transverse exhaust pipes 34′ and 34″ through which exhaust gas flows from the outside to the inside in the vehicle width direction and left and right longitudinal exhaust pipes 35′ and 35″ through which exhaust gas flows from the upper side to the lower side in the up-down direction are connected to first expansion chamber a of exhaust chamber 32. Thus, exhaust gases from the respective cylinders can be securely mixed within first expansion chamber a. Since catalyst 43 is contained in first communication passage 39 through which first expansion chamber a communicates with second expansion chamber b, exhaust gases from the four exhaust pipes 34 and 35 are mixed with one another and flow into catalyst 43 immediately after the mixture. As a result, purification efficiency improves while using only one catalyst. Since only one catalyst is required for the four exhaust pipes, the number of components and costs are decreased.

According to this embodiment, cylindrical body 43a of catalyst 43 penetrates through third expansion chamber c such that first communication chamber a can communicate with second expansion chamber b. In this case, cylindrical body 43a functions as first communication passage 39, and therefore the number of components is decreased.

Catalyst 42 has an elliptical shape in the vehicle width direction. Thus, the size of exhaust chamber 32 in the up-down direction decreases, thereby increasing the minimum road clearance.

According to this embodiment, right transverse exhaust pipe 34′ has extension 34d for guiding exhaust gas from exhaust pipe 34′ to a position away from oxygen concentration detection sensor 42. In this case, exhaust gas from any particular exhaust pipe does not directly contact detection unit 42a of oxygen concentration detection sensor 42. Thus, the air-fuel ratios of all the cylinders can be detected with high accuracy.

According to this embodiment, left and right transverse exhaust pipes 34′ and 34″ and left and right exhaust pipes 35′ and 35″ connected with V-type four-cylinder engine 3 are connected with left and right front inclined walls 37d, 37d and upper wall 37g of exhaust chamber 32, respectively. Thus, the respective exhaust pipes can be arranged in a compact structure without interfering with one another.

According to this embodiment, exhaust chamber 32 is interposed between engine 3 and rear wheel 5. Thus, exhaust chamber 32 having a large volume can be disposed with effective utilization of the space between engine 3 and rear wheel 5.

While, in this embodiment, variable passage area valve 45 is contained in second communication passage 40 through which second expansion chamber b communicates with third expansion chamber c, the variable passage area valve of the invention may be located at any position within the communication passages in the exhaust chamber. For example, the variable passage area valve may be contained in first communication passage 39.

While four exhaust pipes are provided in this embodiment, the invention is applicable to structures containing other numbers of exhaust pipes, such as, for example, one exhaust pipe.

The particular embodiments of the invention described in this document should be considered illustrative, rather than restrictive. Modification to the described embodiments may be made without departing from the spirit of the invention as defined by the following claims.

1. An exhauster for a motorcycle, comprising:
a first exhaust pipe connected with an engine;
an exhaust chamber connected with the first exhaust pipe; and
a second exhaust pipe connected with the exhaust chamber,
wherein the exhaust chamber has a box-shaped chamber main body, a plurality of expansion chambers formed by sectioning an interior of the chamber main body with partitioning walls, and communication passages connecting the expansion chambers, and
wherein a passage area control mechanism that controls passage area is contained in at least in one of the communication passages.

2. The exhauster for a motorcycle according to claim 1, further comprising a catalyst contained in at least in one of the communication passages.

3. The exhauster for a motorcycle according to claim 1, wherein the exhaust chamber has:
a first expansion chamber connected with the first exhaust pipe;
a third expansion chamber connected with the second exhaust pipe; and
a second expansion chamber connected between the first expansion chamber and the third expansion chamber.

4. The exhauster for a motorcycle according to claim 3, wherein the passage area control mechanism has a communication passage through which the second expansion chamber can communicate with the third expansion chamber.

5. The exhauster for a motorcycle according to claim 4, wherein the passage area control mechanism has:
a communication pipe disposed in the vicinity of the side wall of the chamber main body;
a valve shaft disposed to penetrate through the communication pipe; and
a valve plate provided within the communication pipe and fixed to the valve shaft; and
the valve shaft extends in the vehicle width direction and penetrates through the side wall to be exposed to the outside.

6. The exhauster for a motorcycle according to claim 3, further comprising a catalyst which is contained in the communication passage through which the first expansion chamber communicates with the second expansion chamber.

7. The exhauster for a motorcycle according to claim 3, wherein the first exhaust pipe has:
a third exhaust pipe through which exhaust gas flows into the first expansion chamber from the outside to the inside substantially in the vehicle width direction; and
a fourth exhaust pipe through which exhaust gas flows into the first expansion chamber from the upper side to the lower side substantially in the up-down direction.

8. The exhauster for a motorcycle according to claim 7, further comprising an oxygen concentration detection sensor whose detection unit is disposed within the first expansion chamber.

9. The exhauster for a motorcycle according to claim 8, wherein:
the third exhaust pipe has an extension projecting to the inside of the first expansion chamber; and
the extension is directed away from the oxygen concentration detection sensor.

10. The exhauster for a motorcycle according to claim 7, wherein:
the engine is a V-type engine having a front cylinder and a rear cylinder;
the front end of the third exhaust pipe is connected with the front cylinder; and
the rear end of the third exhaust pipe is connected with the side wall of the first expansion chamber.

11. The exhauster for a motorcycle according to claim 10, wherein:
the front end of the fourth exhaust pipe is connected with the rear cylinder; and
the rear end of the fourth exhaust pipe is connected with the top wall of the first expansion chamber.

12. The exhauster for a motorcycle according to claim 10, wherein:
the engine is a V-type four-cylinder engine having a left front cylinder, a right front cylinder, a left rear cylinder, and a right rear cylinder; and
the third exhaust pipe has a fifth exhaust pipe connected with the left front cylinder, and a sixth exhaust pipe connected with the right front cylinder.

13. The exhauster for a motorcycle according to claim 11, wherein:
the engine is a V-type four-cylinder engine having a left front cylinder, a right front cylinder, a left rear cylinder, and a right rear cylinder; and
the fourth exhaust pipe has a seventh exhaust pipe connected with the left rear cylinder, and an eighth exhaust pipe connected with the right rear cylinder.

14. The exhauster for a motorcycle according to claim 10, wherein:
the third exhaust pipe has an extension projecting to the inside of the first expansion chamber; and
the detection unit of the oxygen concentration detection sensor is interposed between the extension and the side wall of the first expansion chamber connected with the extension.

15. The exhauster for a motorcycle according to claim 3, wherein the first expansion chamber, the third expansion chamber, and the second expansion chamber are arranged in this order from the front of the vehicle.

16. The exhauster for a motorcycle according to claim 6, wherein the communication passage penetrates through the third expansion chamber.

17. The exhauster for a motorcycle according to claim 6, wherein:
the catalyst has an elliptical shape in the lateral cross-sectional view; and
the major axis of the elliptical shape extends in the vehicle width direction.

18. The exhauster for a motorcycle according to claim 15, wherein the passage area control mechanism is contained in the communication passage through which the second expansion chamber communicates with the third expansion chamber.

19. A motorcycle, comprising:
a rear wheel; and
the exhauster according to claim 1,
wherein the exhaust chamber is disposed between the engine and the rear wheel.
